(19) United States
(12) Patent Application Publication
(10) Pub. No.: US 2003/0050922 A1
(43) Pub. Date: Mar. 13, 2003

(54) System and method for obtaining dial-up access number

(76) Inventor: Sundeep Sanghavi, Fairfax, VA (US)

Correspondence Address: SUNDEEP SANGHAVI, 4604 CAMBRYAR ST, FAIRFAX, VA, 22030, US

(21) Appl. No.: 09/950,657

(22) Filed: Sep. 13, 2001

(51) Int. Cl. G06F 7/00

(52) U.S. Cl. 707/3

(57) ABSTRACT

A system and method for determining dial up access number(s) that is/are local to a subscriber's telephone number. The system comprises means for retrieving and storing dial up access numbers; a locality database means including a plurality of NPA-NXXs and associated local NPA-NXXs; and means for determining at least one dial up access number that is local to said telephone number. The system and method assist network and internet users in avoiding toll or long distance charges for accessing the network and internet. The system also flags internet traffic usage.

### FIELD OF THE INVENTION

The present invention relates to methods and systems to access a network or internet service provider and database containing dial up access numbers. Specifically, the invention relates to a system and method for determining dial up access number(s) that is/are local to a subscriber's telephone number. The system also flags internet traffic usage.

### BACKGROUND OF THE INVENTION

In the conventional telephone networks, telephone service subscribers have a specific calling area designated as a local calling area based on their phone number. Each subscriber has a phone number made up of a three-digit area code, called an “NPA”, a three-digit exchange area, referred to as the “NXX”, and a four-digit line number, commonly called “XXXX”. The NPAs and NXXs are stored in databases within Telephone switches and billing systems to determine whether calls are local or long distance. Each switch records a Call Detail Record (CDR) which contains Automatic Number Identification (ANI, phone number) with minute of usage (MOU), telephone switch ID, jurisdiction among other things to be submitted for billing purposes into the billing system.

In order to access the internet, Internet Service subscribers have to dial up their Internet Service provider using numbers that have been identified by the Internet Service Provider as available dial-up access numbers. The Internet Service Provider normally refers the subscriber to their local telephone company to verify the locality of the provided numbers. The Internet Service Provider does not take on the responsibility to notify the subscriber that the numbers provided might not be local to the subscriber. Internet service subscribers normally need to dial into their ISP to gain access to the Internet. The ISPs publish a list of available dial-up access numbers for their users. The ISPs make it clear that they are not responsible for the charges associated with the dial-up process. Many customers have to choose dial-up access numbers by guessing which number will be local for them. The local phone companies do not make it easy for their end-users to identify which phone numbers are local and which potentially can be billed for toll charges. Dial-up ISP customers install software from the ISP that suggests phone number to dial for service, but ISPs doesn't guarantee that it is a local call. They may think it's a local call because it is a familiar area code, but according to the local phone company, it may be a toll call. Unsuspecting consumers for an example may use a dial-up access number for a month at home, for 10 hours a day, and at the end of the month, they get bill from their Local Service, which details the toll charges and/or long distance charges.

In addition to the local versus toll issue presented to users of dial up Internet services, the Federal Communications Commission (FCC) passed the Telecommunications Act of 1996. This allowed for additional local service providers began selling local exchange services to consumers. These changes have brought about tremendous challenges for regulating body to determine a set of rules to clarify the proper inter-carrier compensation for traffic delivered from one carrier to another carrier. The FCC developed a compensation process called Reciprocal Compensation which is a practice followed by the telecommunications carriers to bill each other for use of their facilities for the transmission of local voice traffic. However, there are discrepancies on the identification of Internet Service Providers (ISPs) traffic as local or interstate among the carriers. The Commission concluded that reciprocal compensation has inherent shortcomings with respect to the recovery of costs for originating and terminating telecommunications traffic delivered to ISPs. The Commission concluded in April 2001 with Report and Order #01-131, that traffic delivered to an ISP is considered interstate access traffic, specifically “information access”, therefore not subject to reciprocal compensation. Additionally, rather than immediately eliminate the current system, which has created opportunities for regulatory arbitrage and distorted market incentives, the Commission established a transitional cost recovery mechanism for the exchange of this traffic. Inter-carrier compensation refers to payments among telecommunications carriers resulting from their interconnecting networks. Reciprocal compensation refers to the payments among carriers for the origination and termination of local telecommunications traffic (there is a separate payment scheme for payments for “long distance” calls, referred to as access charges). The telecommunication carriers are then responsible for identifying the ISP traffic and removing it form the billing cycles.

### SUMMARY OF THE INVENTION

The invention provides a system and process to identify local/toll/long distance dial-up numbers used for internet traffic. The invention is to provide a system to accumulate Dial-up Access Phone Numbers for all Internet Service Providers (ISPs) and format the numbers to be stored in a DAN database. The system uses the DAN database to determine the dial-up ISP number that is a local, toll or long distance call to the dial-up access line. Through a communications link with each of the ISPs, published documents, or database, the database collects the information about the particular dial-up access numbers and identifies the exchanges that are within local calling areas, toll area, and/or long distance areas. The DAN system provides list of numbers that are ISP dialup access numbers and local to a particular exchange. ISPs will be able integrate the DAN system with their pre-existing mechanism in use to let customers know if the dial-up number they have selected is a Local or Toll or Long Distance call with a Parental Control option. The carriers in the telecommunications industry will have access to the DAN system for purposes of verifying their inter-carrier bills and the exclusion of the billing for internet traffic. Network or internet users/subscribers can access the system to avoid the high costs of toll and/or long distance charges.

### BRIEF DESCRIPTION OF THE DRAWINGS

FIG. 1 illustrates a system architecture that provides local dial up access number(s).

FIGS. 2-3 illustrate a flow diagram for retrieving local dial up access numbers.

FIG. 4 illustrates a system for validating internet usage of a carrier recip comp invoices.

### DETAILED DESCRIPTION OF THE INVENTION

Before describing in detail the preferred embodiments of the invention, a glossary of terms and acronyms to be used is necessary as follows:

ANI: Automatic Number Identification. A Caller's full telephone number.

NPA: The area code from which a call originates. This is also the first three digits of the ANI.

NXX: The telephone exchange from which a call originates. The NXX immediately follows the NPA in the ANI.

LD: Long Distance.

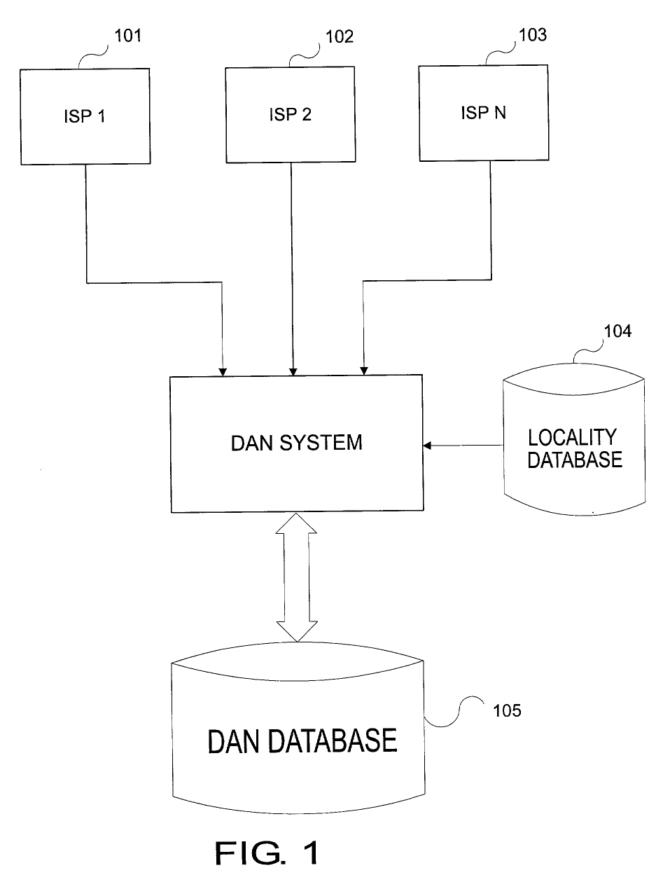

FIG. 1 is a diagram illustrating a system that retrieves dial up access numbers and maps them with a locality database. The dial-up access numbers are retrieved from the Internet Service Providers (ISPs) 101, 102, 103 through various available communications channels. A DAN system 106 retrieves the dial up access numbers and converts them into a storable data format for a DAN database 105. Alternatively, the dial up access numbers can be manually retrieved from all the ISPs and entered into the DAN database 105. The DAN database 105 includes all ISP Dial-up numbers by state and locality.

A locality database 104 includes a listing of all of the NPA NXX listings and their associated local calling NPA NXXs. The locality of the NPA NXXs is determined differently based on each state, city and LATA. The locality is designated by local communication providers based on mileages and bands between the exchanges. The DAN system 106 matches the numbers acquired from the ISPs against the locality database 104. The DAN system also keeps update on new or deleted dial up access numbers of all the ISPs as well as new or change in NPA NXXs and associated local NPA NXXs. Subscribers or users can also access the DAN system 106 via a telephone or any other electronic mediums.

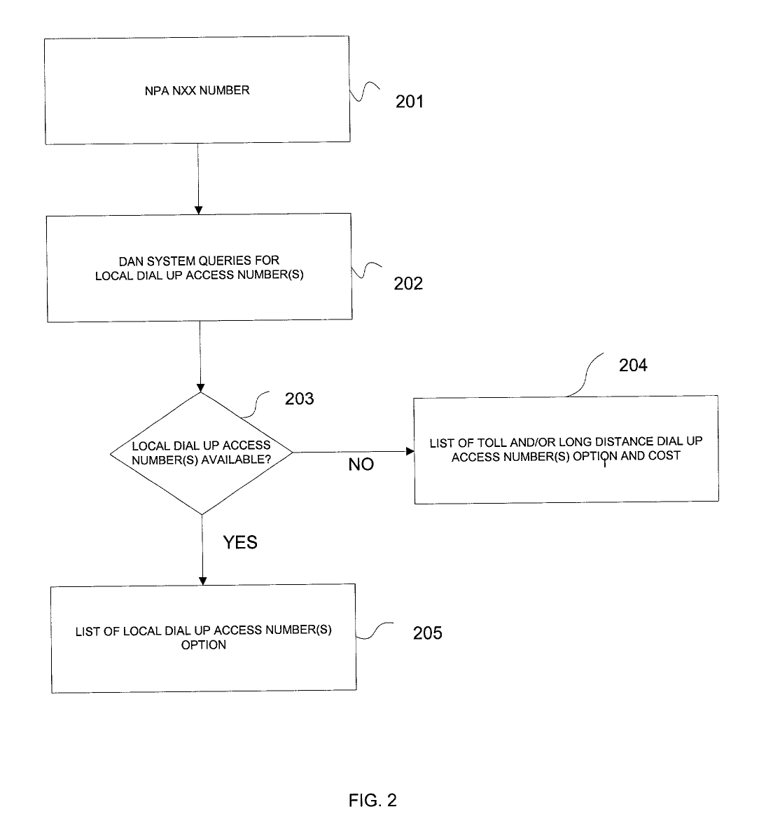

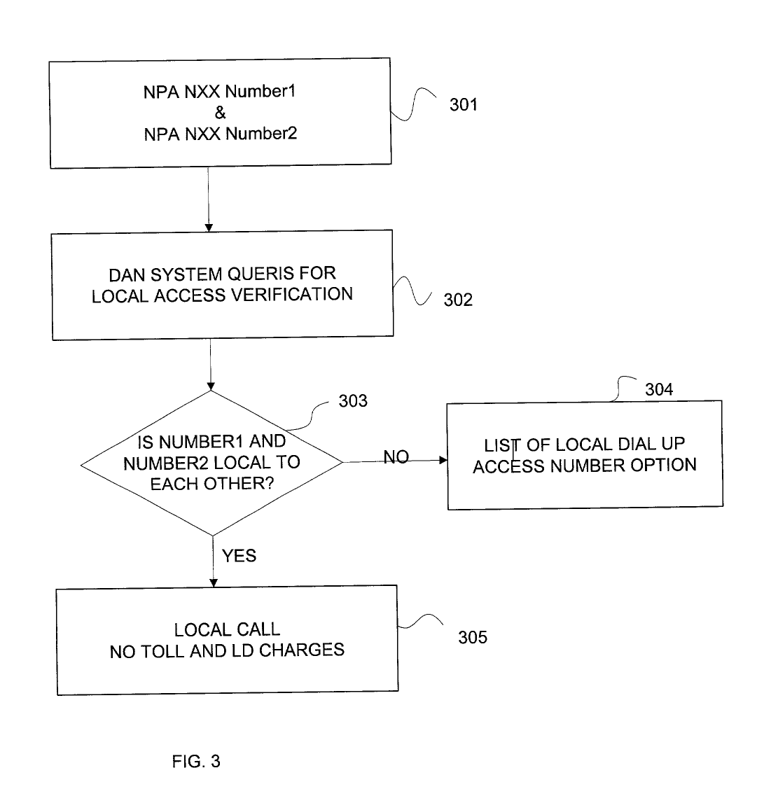

FIGS. 2-3 illustrate a method for determining dial up access number(s) that is/are local, toll, or long distance to a user/subscriber's telephone number. A local ISP dial up access numbers are accessed in response to an input number from a user/subscriber. Step 201 is an entry point. At step 201, the user inputs a number (NPA NXX XXXX) that they are dialing from. In step 202 the DAN system queries for ISP specific dial up access numbers that is local to the entered number in step 201. Subsequently in step 203, the DAN system determines if local dial up access numbers available. If so the DAN system lists the dial up access numbers of the specific ISP that is local to the input number in step 201. If there is no local access number available, at step 204 the user gets notification as to the no local dial up access number available and provided with list of available toll, LD, and 800 dial up access numbers optionally included with appropriate charges.

It should be noted that the dial up access numbers are provided for the specific ISP. Alternatively, the user can access the local dial up access numbers of all the ISPs. The DAN system can also be employed to help select ISP with most dial up access numbers that are local to the user's locality. The DAN system can be used by ISPs to design and implement their dial up access networks in particular state and locality based on dial up access offered by other ISPs.

The DAN system can be integrated with ISPs service package. The subscribers enter NPA (Area Code) and NXX (Exchange) into the integrated DAN system. As discussed above, with reference to FIG. 2, the DAN system provides a list of local Dial-up Access numbers for that subscriber's location. The DAN system can be employed to provide Parental Control where the user is restricted to the dial up access numbers that are local to the number they are calling from. The DAN system can also be employed to automatically identify the number they are calling from and restrict the access only to local dial up access numbers.

Referring to FIG. 3, the DAN system verifies NPA NXX Number1 and NPA NXX Number2 are local to each other. At step 301, the user inputs NPA NXX Number1 and NPA NXX Number2. In step 302, the DAN system queries for local access verification. Subsequently, the DAN system determines if the Number1 is local to the Number2 at step 303. If it is the local call (i.e. no toll or LD charges), the system notifies the user that the call is local and no toll or LD charges will apply at step 305. Otherwise, the users get warning as to applicable toll or LD charges. In step 304, the user also receives list of dial up access numbers that are local to the Number1 entered in step 301. Alternatively, the system can also provide information on all the ISPs available that have local numbers to the number1. The DAN system gives travelers an efficient tool to access the internet vial local dial up access numbers through out United States. If local number is not available travelers get warning and list of available toll, long distance, and 800 dial up access numbers.

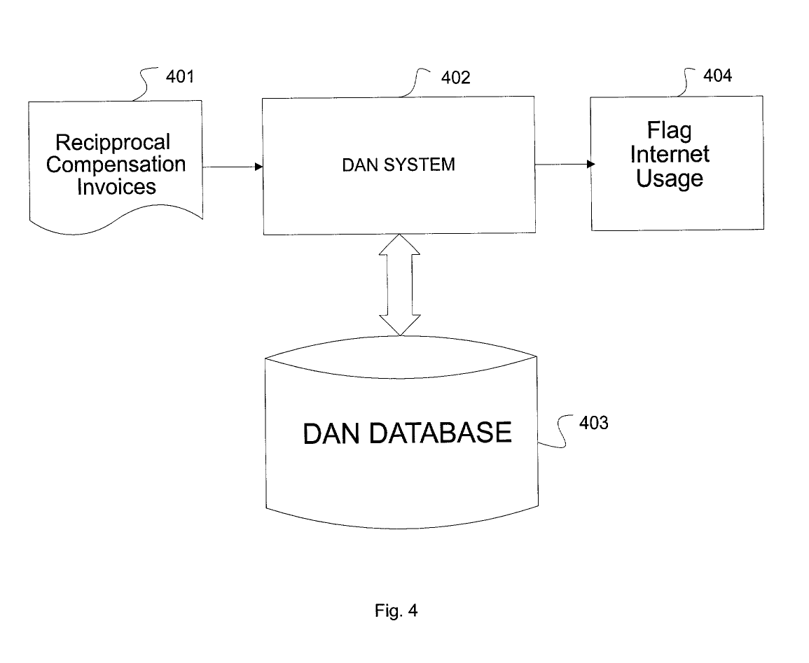

The DAN system is also used to validate the intercarrier billing Carriers receive in the form of a Reciprocal Compensation bill. The DAN system is linked for update on dial up access numbers of all the ISPs. FIG. 4 illustrates the DAN system validating Reciprocal Compensation invoices 401 received from the other carriers. Using the DAN database 403, the DAN system 402 matches the Carriers CDR ANI listing to the ISPs dial up access numbers. If there is a match, the usage gets flag as an internet usage (404) and the carrier can use the data to dispute the Reciprocal Compensation charged on the invoice.

It is to be understood that the above description is only one of the preferred embodiment of the invention. Numerous other arrangements may be devised by one skilled in the art without departing from the spirit and scope of the invention. The invention is thus limited only as defined in the accompanying claims.

I claim:

1. A method for obtaining a local dial up access number comprising the steps of:
responsive to receipt of a telephone number from a user, sending a query to retrieve at least one dial up access number that is local to said telephone number;
responsive to receipt of said query, reporting at least one dial up access number that is local to said telephone number.

2. The method of claim 1 further including the steps of reporting toll, long distance or 800 dial up access numbers to said telephone number.

3. A system for obtaining dial up access numbers which is local to a telephone number, said system comprising:
means for retrieving and storing dial up access numbers;
a locality database means including a plurality of NPA-NXXs and associated local NPA-NXXs; and
means for determining at least one dial up access number that is local to said telephone number.

4. The system of claim 3, further including means for updating dial up access numbers.

5. The system of claim 3, further including means for updating said NPA-NXXs and associated local NPA-NXXs.

6. The system of claim 3, further including means for determining toll, long distance, or 800 dial up access numbers.

7. The system of claim 3, further including means for restricting dialing access to a local dial up access number.

8. A system for auditing carrier invoices on internet usage comprising:
means for retrieving and storing dial up access numbers of internet service providers;
means for receiving invoices including telephone numbers and matching said telephone numbers against said dial up access numbers;
means for identifying the matched telephone numbers; and
reporting internet usage on said matched telephone numbers.
